(19) United States
(12) Patent Application Publication
(10) Pub. No.: US 2008/0181547 A1
(43) Pub. Date: Jul. 31, 2008

(54) MOTOR AND ITS BEARING SUPPORTING STRUCTURE

(76) Inventors: Zhin-Chang CHEN, Taoyuan Hsien (TW); Hong-Tu Zhou, Taoyuan Hsien (TW); Jian-Bin Liu, Taoyuan Hsien (TW)

Correspondence Address: BIRCH STEWART KOLASCH & BIRCH, PO BOX 747, FALLS CHURCH, VA, 22040-0747, US

(21) Appl. No.: 11/960,490

(22) Filed: Dec. 19, 2007

(30) Foreign Application Priority Data
Jan. 26, 2007 (TW) 096103002

(51) Int. Cl. H02K 5/167; F16C 35/02

(52) U.S. Cl. 384/428; 310/90; 310/91

(57) ABSTRACT

A motor and its bearing supporting structure are disclosed. The bearing supporting structure supporting a shaft includes a bushing, a bearing and at least one first limiting assembly. The bushing has an opening and an accommodating space. The bearing supports at least a portion of the shaft and is disposed in the accommodating space. The first limiting assembly is disposed at a connection of the bearing and the bushing.

### CROSS REFERENCE TO RELATED APPLICATIONS

This Non-provisional application claims priority under 35 U.S.C. §119(a) on Patent Application No(s). 096103002, filed in Taiwan, Republic of China on Jan. 26, 2007, the entire contents of which are hereby incorporated by reference.

### BACKGROUND OF THE INVENTION

1. Field of Invention

The present invention relates to a motor and its bearing supporting structure, and, in particular; to a bearing supporting structure for fixing a bearing to prevent it from being moved relative to a bushing, and a motor having the bearing supporting structure.

2. Related Art

An electronic device (e.g., a fan or a hard disk drive) has a rotatable component, which is often driven by a motor. The driving element has a bearing for supporting a shaft to rotate.

Referring to FIG. 1, a conventional bearing supporting structure 1 has a bushing 11 and a bearing 12. The bushing 11 has an opening 111, and the bearing 12 is disposed in the bushing 11. A shaft S passes through the bearing 12 and is supported by the bearing 12. In order to keep the bearing 12 work stably, it is necessary to prevent the bearing 12 from being moved in a circumferential direction with respect to the bushing 11. The circumference of the bearing 12 is usually fixed by way of interference fitting (the force applying directions are indicated by the arrows) or by filling an adhesive in between the bushing 11 and the bearing 12.

Also, a cap 13 of the bearing supporting structure 1 is directly pressing against the bearing 12 in an axial direction. However, the bearing supporting structure does not have the buffer design. Thus, the bearing 12 will be influenced by the variations of the material and the manufacturing process so that no force is applied to the bearing 12 or the force applied to the bearing 12 is too large to make an inner hole of the bearing 12 shrink or deform. Therefore, the shaft S cannot be rotated smoothly or may even be jammed.

Furthermore, the variations of the material and the manufacturing process caused by the interference fitting will make the bearing 12 be over forced so that the inner hole thereof may deform or shrink. Thus, the bearing 12 is abnormally worn, the reliability thereof is influenced and the product lifetime is shortened, and even the shaft S may be jammed. In addition, the use of the adhesive will cause the drawback of the insufficient adhesive intensity, or the drawback that the adhesive enters the inner hole of the bearing 12 to make the shaft S be jammed.

In addition, the process of manufacturing the bushing 11 also has some drawbacks. If the bushing 11 is formed by way of plastic molding, the molding machine has high investment cost, high mold cost, poor stability (because it tends to be deformed or softened when heated) and poor temperature reliability. If the bushing 11 is formed by way of turning, the apparatus (CNC lathe) has high investment cost, poor throughput (about 3000 to 5000 pieces per 24 hours), large material waste (the availability is lower than 60%), higher cost and difficulty of the stability control. If the bushing 11 is formed by way of hot pressing, the die-casting machine has high investment cost, high mold cost and poor dimensional stability. Also, if the precise dimension has to be obtained, the secondary precise machining is needed and the machining cost is much higher.

### SUMMARY OF THE INVENTION

In view of the foregoing, the present invention also provides a motor and its bearing supporting structure for fixing a bearing and preventing the bearing from being moved in a circumferential direction and an axial direction so that the product reliability and the efficiency can be enhanced

In view of the foregoing, the present invention further provides a motor and its bearing supporting structure, which has the enlarged allowance in designing the shape of the structure according to an optimum manufacturing method and can prevent the problems of the material waste and the variation during the manufacturing process.

To achieve the above, the present invention discloses a bearing supporting structure for supporting a shaft. The bearing supporting structure includes a bushing, a bearing and at least one first limiting assembly. The bushing has an opening and an accommodating space. The bearing is disposed in the accommodating space for supporting a portion of the shaft and. The first limiting assembly is disposed at a connection of the bearing and the bushing for preventing the bearing from being moved relative to the bushing.

To achieve the above, the present invention discloses a motor, which includes a fixing structure, a bearing supporting structure, a circuit board and a stator. The circuit board is electrically connected to the stator. The bearing supporting structure is used to support a shaft and includes a bushing, a bearing and at least one first limiting assembly. The bushing has an opening and an accommodating space. The bearing is disposed in the accommodating space for supporting at least a portion of the shaft. The first limiting assembly is disposed at a connection of the bearing and the bushing for preventing the bearing from being moved relative to the bushing. The fixing structure covers and fixes at least a portion of the bushing, and the circuit board is disposed in the fixing structure.

As mentioned above, the bearing supporting structure according to the present invention has the circumferential limiting assembly between the bearing and the bushing so that the circumferential rotation of the bearing relative to the bushing can be avoided. Compared with the related art, the present invention does not need the adhesive so that the problem of the adhesive intensity can be avoided and it is possible to prevent the adhesive from entering the inner hole of the bearing. In addition, the present invention does not need the interference fit so that it is possible to prevent the inner hole of the bearing from being forced to deform or shrink and to prevent the shaft from being jammed. Thus, the product reliability and the efficiency can be enhanced.

In addition, the present invention further has the axial limiting assembly or the limiting portion of the bushing pressing against the bearing to prevent the bearing from being moved axially so that the overall reliability and efficiency can be enhanced. Furthermore, the present invention changes the method of manufacturing the members by way of non-cutting cold working so as to eliminate the limitation to the shape of the structure, to enlarge the design allowance and to avoid the problems of the material waste and the variation during the manufacturing process.

### BRIEF DESCRIPTION OF THE DRAWINGS

The present invention will become more fully understood from the detailed description and accompanying drawings, which are given for illustration only, and thus are not limitative of the present invention, and wherein:

FIG. 1 is a schematic illustration showing a conventional bearing supporting structure;

FIG. 2 is a schematic illustration showing a bearing supporting structure according to an embodiment of the present invention;

FIGS. 3A and 3B are top views showing the bearing supporting structures according to the embodiment of the present invention, wherein the first limiting assemblies has different variations;

FIG. 4 is a schematic illustration showing the bearing supporting structure connected to a fixing structure according to the embodiment of the present invention;

FIG. 5 is a schematic illustration showing that a bushing of the bearing supporting structure has a convex portion to be connected to the fixing structure according to the embodiment of the present invention;

FIG. 6 is a schematic illustration showing that the bushing of the bearing supporting structure is connected to the fixing structure in a deformed manner according to the embodiment of the present invention; and

FIG. 7 is a schematic illustration showing a ball bearing and the bushing combined with a motor according to the embodiment of the present invention, wherein the bushing is formed by way of cold forging, cold heading or cold extruding.

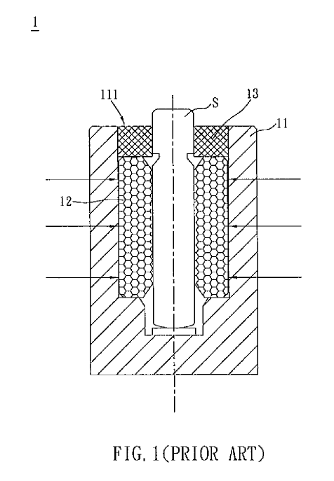

### DETAILED DESCRIPTION OF THE INVENTION

The present invention will be apparent from the following detailed description, which proceeds with reference to the accompanying drawings, wherein the same references relate to the same elements.

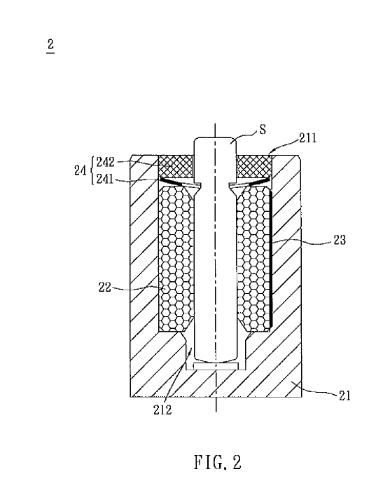

Referring to FIG. 2, a bearing supporting structure 2 according to an embodiment of the present invention is for supporting a shaft S and includes a bushing 21 and a bearing 22. The bushing 21 has an opening 211 and an accommodating space 212. The bearing 22 is disposed in the accommodating space 212 of the bushing 21. The shaft S passes through the bearing 22, and the bearing 22 is for supporting at least a portion of the shaft S. The bearing supporting structure 2 further includes at least one first limiting assembly 23, such as a circumferential limiting assembly, disposed at a connection of the bearing 22 and the bushing 21 to prevent the bearing 22 from being rotated circumferentially, for example, relative to the bushing 21. The bearing 22 may be a sleeve bearing, a ball bearing or a fluid dynamic bearing.

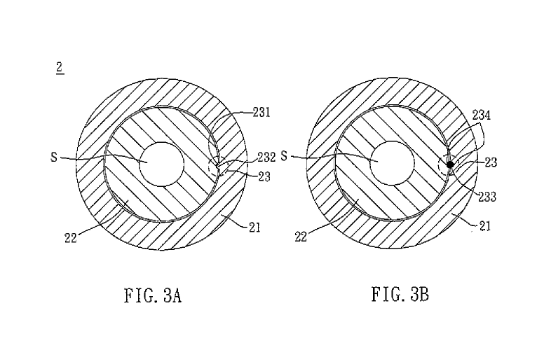

In this embodiment, the first limiting assembly 23 has various modifications. FIGS. 3A and 3B are top views showing the bearing supporting structures 2. The first limiting assembly 23 has a concave portion 231 and a convex portion 232 disposed opposite to the concave portion 231. The convex portion 232 is disposed on an inner wall of the bushing 21, and the concave portion 231 is disposed on an outer wall of the bearing 22. Alternatively, the concave portion 231 can be disposed on the inner wall of the bushing 21, and the convex portion 232 can be disposed on the outer wall of the bearing 22. In addition, the concave portion 231 or the convex portion 232 can be integrally formed with the bushing 21 or the bearing 22. In addition, the first limiting assembly 23 can also have a rib 233 and two concave portions 234. The two concave portions 234 are respectively and correspondingly disposed on the inner wall of the bushing 21 and the outer wall of the bearing 22. The rib is disposed between the two concave portions 231, as shown in FIG. 3B.

Referring to FIG. 2, the bearing supporting structure 2 further includes a second limiting assembly 24, which is disposed at the opening 211 and presses against the bearing 22, for limiting the axial movement of the bearing 22. Herein, the second limiting assembly 24 includes an elastic member 241, which presses against the bearing 22, engages with the outer wall of the shaft S, and provides a pie-pressing force to the bearing 22. Herein, the elastic member 241 can be an elastic gasket or an elastic washer. The second limiting assembly 24 further includes a cover 242 for covering the opening 211 and pressing against the elastic member 241. The cover 242 limits the axial movement of the bearing 22. The elastic member 241 serves as a buffer so that the cover 242 does not apply a force to the bearing 22 directly. Thus, it is possible to prevent the cover from directly pressing against the bearing and thus to prevent the cover from being greatly forced in the prior art. This great force makes the inner hole of the bearing deform or shrink to make the shaft S be jammed. In addition, the second limiting assembly 24 can also be a limiting portion formed and extended from the inner wall of the bushing 21. The limiting portion is disposed at the opening 211 and presses against the bearing 22. Similarly, an elastic member can be disposed between the limiting portion and the bearing 22 so that the limiting portion cannot directly apply the force to the bearing 22 and the buffering effect can be achieved.

In this embodiment, the material of the bushing 21, the elastic member 241 or the cover 242 can be a soft metal or an alloy thereof, wherein the soft metal is aluminum or tin, for example. Because the soft metal is used, the bushing 21, the elastic member 241 or the cover 242 can be formed by way of non-cutting cold working, such as cold forging, cold heading or cold extruding. Thus, the working limitation, high cost and material waste caused by the working method, such as plastic molding, metal turning or hot pressing, in the related art can be avoided so that the cost can be saved and the environment protection can be achieved. In addition, it is verified that this embodiment can increase the conventional throughput of 3000 to 5000 pieces per 24 hours to the throughput of 20,000 pieces per 24 hours by way of one-time working, such as cold forging, cold heading or cold extruding, without waste product.

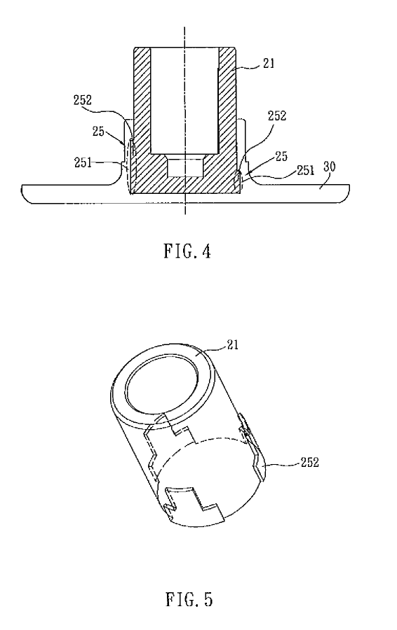

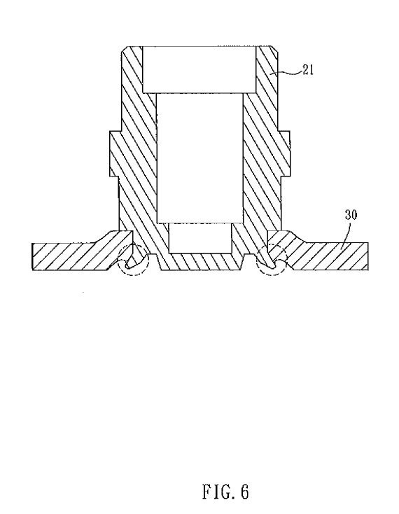

As shown in FIG. 4, the bearing supporting structure 2 is connected to a fixing structure 30, which covers and fixes at least a portion of the bushing 21, and the material for fixing the bushing is plastic or low-temperature metal. In this embodiment, the bearing supporting structure 2 is applied to a motor, and the fixing structure 30 is a base of the motor. Moreover, the motor can be applied to an axial-flow or a centrifugal fan. In addition, the bearing supporting structure 2 further includes a third limiting assembly 25, which is also an axial limiting assembly disposed at the connection of the bushing 21 and the fixing structure 30. Herein, the third limiting assembly 25 has a concave portion 251 and a convex portion 252 disposed opposite to the concave portion 251. The concave portion 251 is disposed on the inner wall of the fixing structure 30, and the convex portion 252 is disposed on the outer wall of the bushing 21, as shown in FIG. 5. Alternatively, the convex portion 252 can be disposed on the inner wall of the fixing structure 30, and the concave portion 251 can be disposed on the outer wall of the bushing 21. In addition, the bushing 21 can also be partially connected to the fixing structure 30 in a deformed manner, as shown in the dashed-line regions of FIG. 6.

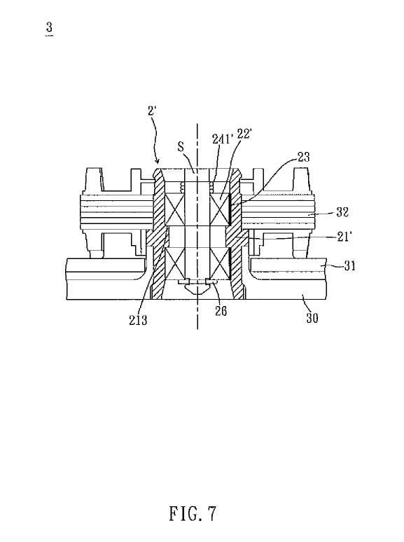

Referring to FIG. 7, another bearing supporting structure 2′ includes a bushing 21′ and at least one bearing 22′. The differences between the bearing supporting structure 2′ and the above-mentioned bearing supporting structure 2 will be described in the following. The bushing 21′ has at least one limiting portion 213, the bearings 22′ are two ball bearings, the limiting portion 213 presses against the bearings 22′, and the bearings 22′ are positioned using the elastic member 241′ in conjunction with a positioning sheet 26. The elastic member 241′ is a pre-pressed spring for providing a pre-pressing force to the bearing 22′. The positioning sheet 26 is an annular sheet embedded into the shaft S to press the bearing 22′. In addition, the bushing 21′ is formed by way of cold forging, cold heading or cold extruding. The bearing supporting structure 2′ further includes at least one first limiting assembly 23, which is disposed at the connection of the bearing 22′ and the bushing 21′ to prevent the bearing 22′ from rotating relative to the bushing 21′ in the circumferential direction.

When the bearing supporting structure 2′ is applied to a motor 3, the bearing supporting structure 2′ is connected to the fixing structure 30 of the motor 3 in advance. The connection can be made by using the third limiting assembly 25 shown in FIG. 4 or the deformation method shown in FIG. 6, or by way of adhering, embedding, screwing or welding. Next, a circuit board 31 and a stator 32 are sequentially fit with the bearing supporting structure 2′.

In summary, the bearing supporting structure according to the present invention has the circumferential limiting assembly between the bearing and the bushing so that the circumferential rotation of the bearing relative to the bushing can be avoided. Compared with the related art, the present invention does not need the adhesive so that the problem of the adhesive intensity can be avoided and it is possible to prevent the adhesive from entering the inner hole of the bearing. In addition, the present invention does not need the interference fit so that it is possible to prevent the inner hole of the bearing from being forced to deform or shrink and to prevent the shaft from being jammed. Thus, the product reliability and the efficiency can be enhanced. In addition, the present invention further has the axial limiting assembly or the limiting portion of the bushing pressing against the bearing to prevent the bearing from being moved axially so that the overall reliability and efficiency can be enhanced. Furthermore, the present invention changes the method of manufacturing the members by way of non-cutting cold working so as to eliminate the limitation to the shape of the structure, to enlarge the design allowance and to avoid the problems in the variations of the material and the manufacturing process. Moreover, the throughput can be enhanced and the material waste can be reduced by way of one-time working without waste product.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention,

What is claimed is:

1. A bearing supporting structure for supporting a shaft, the bearing supporting structure comprising:
a bushing having an opening and an accommodating space;
a bearing which supports a portion of the shaft and is disposed in the accommodating space of the bushing; and
at least one first limiting assembly disposed at a connection of the bearing and the bushing for preventing the bearing from being moved relative to the bushing.

2. The bearing supporting structure according to claim 1, wherein the first limiting assembly comprises a concave portion and a convex portion, both of which are disposed opposite to each other.

3. The bearing supporting structure according to claim 2, wherein the concave portion is disposed on an inner wall of the bushing, and the convex portion is disposed on an outer wall of the bearing, and vice versa.

4. The bearing supporting structure according to claim 1, further comprising a second limiting assembly which is disposed at the opening and presses against the bearing.

5. The bearing supporting structure according to claim 4, wherein the second limiting assembly is extended from an inner wall of the bushing and is an axial limiting assembly for limiting an axial movement of the bearing.

6. The bearing supporting structure according to claim 4, wherein the second limiting assembly further comprises a cover and an elastic member pressing against the bearing.

7. The bearing supporting structure according to claim 6, wherein the elastic member is an elastic gasket or an elastic washer, or the elastic member and the cover comprises a soft metal or an alloy of the soft metal.

8. The bearing supporting structure according to claim 6, wherein the cover presses against the elastic member and covers the opening.

9. The bearing supporting structure according to claim 1, further comprising:
at least one third limiting assembly disposed at a connection of the bushing and a fixing structure, wherein the fixing structure covers and fixes a portion of one end of the bushing.

10. The bearing supporting structure according to claim 9, wherein the bushing is connected to the fixing structure in a deformed manner.

11. A motor, comprising:
a fixing structure;
a bearing supporting structure for supporting a shaft, the bearing supporting structure comprising:
a bushing having an opening and an accommodating space,
a bearing which supports a portion of the shaft and is disposed in the accommodating space of the bushing; and
at least one first limiting assembly disposed at a connection of the bearing and the bushing for preventing the bearing from being moved relative to the bushing;
a circuit board; and
a stator electrically connected to the circuit board, wherein the fixing structure covers and fixes at least a portion of the bushing, and the circuit board is disposed in the fixing structure.

12. The motor according to claim 11, wherein the first limiting assembly comprises a concave portion and a convex portion, both of which are disposed opposite to each other.

13. The motor according to claim 12, wherein the concave portion is disposed on an inner wall of the bushing, and the convex portion is disposed on an outer wall of the bearing, and vice versa.

14. The motor according to claim 11, wherein the bearing supporting structure further comprises a second limiting assembly which is disposed at the opening and presses against the bearing.

15. The motor according to claim 14, wherein the second limiting assembly is extended from an inner wall of the bushing and is an axial limiting assembly for limiting an axial movement of the bearing.

16. The motor according to claim 14, wherein the second limiting assembly further comprises a cover and an elastic member pressing against the bearing, the elastic member is an elastic gasket or an elastic washer, or the elastic member and the cover comprises a soft metal or an alloy of the soft metal.

17. The motor according to claim 16, wherein the cover presses against the elastic member and covers the opening.

18. The motor according to claim 11, wherein an inner wall of the bushing has a limiting portion located at the opening and pressing against the bearing,

19. The motor according to claim 11, wherein the bearing supporting structure further comprises:
at least one third limiting assembly disposed at a connection of the bushing and a fixing structure, wherein the fixing structure covers and fixes a portion of the bushing, and the bushing is connected to the fixing structure in a deformed manner.

20. The motor according to claim 19, wherein the first limiting assembly is a circumferential limiting assembly and the third limiting assembly is an axial limiting assembly.
